(19) United States
(12) Patent Application Publication
(10) Pub. No.: US 2025/0035214 A1
(43) Pub. Date: Jan. 30, 2025

(54) SOFT SENSOR AND METHOD FOR DETERMINING THE FRICTIONAL POWER OF A MECHANICAL SEAL BY ESTIMATION, AND PUMP THEREWITH

(71) Applicant: Herborner Pumpentechnik GmbH & Co KG, Herborn (DE)

(72) Inventors: Sascha KORUPP, Asslar-Werdorf (DE); Nils REEH, Herborn (DE); Benjamin ORTMÜLLER, Siegbach (DE)

(21) Appl. No.: 18/782,166

(22) Filed: Jul. 24, 2024

(30) Foreign Application Priority Data
Jul. 28, 2023 (DE) 10 2023 120 204.9

(51) Int. Cl. F16J 15/34

(52) U.S. Cl. CPC F16J 15/3492

(57) ABSTRACT

A soft sensor for determining a frictional power of a mechanical seal by estimation has a data interface designed to receive data signals regarding a ring temperature of a sliding or mating ring of the mechanical seal and a medium temperature of the flow medium on the side of the mechanical seal facing the sliding ring and outside of a sealing gap between the sliding ring and the mating ring as an input variable of the soft sensor. The soft sensor is designed to estimate frictional power by evaluating the data signals using a heat flux model, the model configured to describe heat fluxes in the mechanical seal on the basis of a temperature difference between the ring temperature and the medium temperature, the model configured to deduce frictional power by way of the heat fluxes. The soft sensor is used with a pump and method for determining frictional power.

Soft sensor and method for determining the frictional power of a mechanical seal by estimation, and pump therewith

The invention relates to a soft sensor, in particular for determining a frictional power of a mechanical seal by estimation, as claimed in claim 1. Moreover, the invention relates to a pump having such a soft sensor, as claimed in claim 11. Finally, the invention relates to a computer-implemented method for estimating a frictional power of a mechanical seal, as claimed in claim 14.

Mechanical seals and pumps therewith are known from the prior art. In this case, a sliding ring is seated on a pump shaft and corresponds to a mating ring in a mating ring seat of a housing through which the pump shaft is guided. The primary seal of the rotary feedthrough formed thus is implemented by means of a sealing gap between the sliding ring and the mating ring. The pump according to the invention can also be configured thus. In this case, the gap height and hence the frictional resistance of the seal correlates with the pressure force of the sliding ring on the mating ring and opposite forces which emerge from the surface structure in the sliding gap, the penetrating fluid film and the shaft rotational speed.

It was presently determined that an improper prestress of the sliding ring in the direction of the mating ring already causes a power consumption of up to 8% of the overall motor power, while the corresponding figure in the case of a proper prestress is only approximately 1%. Contamination of the spring and sliding faces, spring fatigue, temperature changes and surface modifications due to wear and tear can change the prestress and sealing gap formation, with the result that the power consumption can undesirably increase over the duration of use.

The prior art has disclosed various procedures for measuring the operational state of mechanical seals. Thus, EP 0 886 088 A2 has described a method in which the pressure of the flow medium, the temperature of the flow medium, the mating ring temperature, the leakage pressure and the moisture on the side of the mechanical seal facing away from the medium are measured for the purpose of ascertaining the outage probability or predicted remaining service life of mechanical seals. In this case, the measured values are captured cyclically at frequencies between 0.1 and 2.0 Hz. Six states which correlate with the individual measured values by way of comparison values are defined for the evaluation. In these states, the measured values of pressure and temperature are compared on an individual basis with comparison values. A traffic light-type visualization of the sealing state is controlled by a state combination that is linked with the preceding operational time. For the comparison values and correlations, comprehensive data regarding the individually installed seal are required for the definition of limit values. Additionally, the traffic light-type visualization has only a very low information density and thus provides no specific information regarding the state, possible outage causes and the search for remedial action.

Another variable for the assessment of the state of a mechanical seal is the moment of friction. According to WO 2010/142367 A1 or EP 2 440 816 A1, the latter is measured directly on the mating ring of the mechanical seal. To this end, a bending bar which measures the torsion angle of the mating ring in the mating ring seat and derives the moment of friction therefrom is arranged between mating ring and mating ring seat. The measured moment of friction is processed in an evaluation device, wherein the operational state of the mechanical seal can be determined in this case. However, this method does not allow any statements to be made with regards to the state of the flow medium in the sealing gap or the temperature of the mating ring. Moreover, the mating ring and the mating ring seat are required to have appropriate receptacles, e.g. suitable grooves or drilled holes, for the bending bar engagement. Sealing is difficult in this case on account of the required degree of freedom of rotation of the mating ring in the mating ring seat.

EP 4 008 934 A2 describes an evaluation system which detects the state and, in particular, the loss of lubricant in the sealing gap of mechanical seals. The temperature of the flow medium in the vicinity of the seal, the acoustic emissions in the vicinity of the mechanical seal, the seal rotational speed and the flow medium pressure are measured in this case. Various logic modules are found integrated in the evaluation system, and these can detect error states and thereby calculate the probability of outage of the seal. Loss of flow medium in the sealing gap, a flow rate through the sealing gap that is too low, pressure reversal of the flow medium or cavitation can be identified as causes of outage. Since a plurality of sensors can be installed for each measured variable, the system can create a comprehensive and high-resolution image of the mechanical seal. The information density regarding the state of the mechanical seal should be classified as very high, but this also applies to the complexity and hence integration costs at the same time.

DE 10 2015 226 311 A1 specifies a method in which the sealing gap is monitored by Lamb-Rayleigh waves. To this end, a transmitter and a receiver which induce and evaluate Lamb-Rayleigh waves in the ring should be applied to the sliding ring or mating ring. Conclusions about the sealing gap, e.g. the sealing gap height or the gap filling ratio, can be deduced from the change in signal between transmitter and receiver. The information density for the sealing state should be classified as average since this only relates to one measured value and thus does not allow the generation of a comprehensive picture of the seal.

WO 2008 148 496 A1 describes a method in which operational states of a mechanical seal are detected on the basis of temperature measurements on the mating ring of the mechanical seal. In this case, the mating ring is monitored by at least two temperature sensors in order to determine a temperature gradient between the measurement sites. Operational states of the mechanical seal such as normal operation or dry run can be identified from the temperature gradient in the mating ring. However, this requires the mating ring to be equipped with a plurality of temperature sensors, with the temperature measurement on the sliding face in the sealing gap in particular meaning a significant integration outlay.

The object of the invention is therefore that of providing a cost-effective solution which allows statements that are as precise as possible to be made regarding the current state and the state of wear of a mechanical seal and which requires little outlay in terms of integration.

Main features of the invention are specified in claims 1, 11 and 14. Refinements are the subject matter of claims 2 to 10, 12 to 13 and 15 to 16.

The invention relates to a soft sensor, in particular for determining a frictional power of a mechanical seal by estimation, having a data interface designed to receive data signals regarding a ring temperature of a sliding ring or mating ring of the mechanical seal and a medium temperature of the flow medium on the side of the mechanical seal facing the sliding ring and outside of a sealing gap between the sliding ring and the mating ring, in each case as an input variable of the soft sensor. The soft sensor also has an evaluation device designed to estimate the frictional power by evaluating the data signals, for which purpose the evaluation device has an evaluation model comprising a heat flux model, the heat flux model being configured to describe heat fluxes in the mechanical seal on the basis of a temperature difference between the ring temperature and the medium temperature and the evaluation model being configured to deduce the frictional power by way of the heat fluxes.

Knowledge of the ring temperature at a measurement position and of the medium temperature as a limit temperature of the faces of the mechanical seal adjacent to the fluid outside of the sealing gap allows a heat flux to be deduced with the aid of the evaluation model, and hence also a heat input into the sliding and/or mating ring in the sealing gap. This heat input correlates with the frictional power. Thus, the estimation can be understood to be a model calculation which only allows an approximation, especially on account of model errors. A dry run of the mechanical seal, for example, is thus identified in a simple manner. The procedure is based on the approach that the temperature difference and/or a change in the temperature difference between ring temperature and medium temperature is the consequence of the frictional power of the mechanical seal. The evaluation model should be configured to draw conclusions about the heat flux from the temperature difference, the heat flux being transferred into the flow medium from the one of sliding ring and mating ring on which the ring temperature is determined. The rotational speed can also be considered in the process. This is because the speed of movement of the flow medium at the surfaces of the mechanical seal is an influencing factor that needs to be taken into account when considering the heat transfer from the mechanical seal to the flow medium. For example, the flow medium circulates in the pump housing in a manner dependent on the rotational speed of the pump wheel, which corresponds to the rotational speed of the sliding ring. Moreover, the sliding ring is in rotation, with the result that this causes flow medium to flow past the surfaces of the sliding ring. On the basis of this, the evaluation model can apply the law of conservation of energy, wherein the dissipated heat (part of the heat fluxes) can be quantified and the frictional power can be deduced therefrom. The actual determination by estimation is performed by the evaluation device, wherein the soft sensor, as overarching assembly, comprises further peripheral means around the evaluation device.

As a rule, all that is needed for the integration of the soft sensor are the evaluation device with the evaluation model and two temperature sensors. The temperature measurement site for measuring the ring temperature of the mechanical seal is preferably located on the side of the mating ring facing away from the sliding ring. The rotational speed is optionally also includable; it is usually known from the pump controller, and so a data interface is sufficient to this end. Once the current frictional power is known, observations over time also yield the wear and tear of the mechanical seal since conclusions about the frictional state can be drawn from the frictional power. The flow medium is preferably a liquid. This is because the heat transfers from and to the liquid are so significant in this case that transfers of heat to other components tend to be able to be neglected in the estimate. Moreover, knowledge of the frictional power allows the output of discrete statements, for example “critical operating state”, “dry friction”, “mixed friction”, “fluid friction”, “mechanical seal maintenance required”, etc.

In a specific embodiment, the evaluation device is configured to estimate the frictional power in accordance with the heat flux model by way of an estimated heat power introduced into the mechanical seal in the sealing gap. Thus, heat or energy is considered and a law of conservation of energy is modeled over the mechanical seal, the basic assumption of which being that energy is supplied to the mechanical seal in the sealing gap and removed therefrom again outside of the sealing gap. The energy supplied and the frictional power are deduced from the outflow of energy, which emerges from the heat fluxes.

According to a more specific configuration of the soft sensor, provision is made for the evaluation model to include the geometry of the mating ring and the thermal conductivity or conductivities of the materials used to form the mating ring. This describes the static infrastructure of the heat fluxes which is based on the structure of the mating ring.

In an alternative to that or in addition, the evaluation model can include the geometry of the sliding ring and the thermal conductivity or conductivities of the materials used to form the sliding ring. This describes the static infrastructure of the heat fluxes which is based on the structure of the sliding ring.

If the heat flux model is based purely on the geometry of the mating ring and the thermal conductivity or conductivities of its materials, for example, and if this is used to deduce the frictional power in the sealing gap, then the outflow of heat energy from the sealing gap to the flow medium via the sliding ring remains unconsidered, or this outflow must be calculated approximately or estimated. By contrast, if the sliding ring is included in the heat flux model, then the estimate of the frictional power becomes more precise. This applies especially if the ring temperature is determined on the mating ring, which is frequently more practical on account of the stationary installation. However, the same also applies correspondingly conversely if the ring temperature is determined on the sliding ring.

Optionally, the heat flux model additionally obtains the geometry of adjacent components in solid contact with the mechanical seal and the thermal conductivity or conductivities of the materials used to form these adjacent components. Optionally, however, it is also possible to manage perfectly well without this, especially if the flow medium is a liquid. This is because the heat transfer to the flow medium is so significant that the heat fluxes into adjacent components or to the surroundings or ambient air can be neglected.

Furthermore, the heat flux model can be configured to determine heat fluxes (especially internal heat fluxes) between surfaces of the one of sliding ring and mating ring on which the ring temperature is determined, specifically on the basis of the medium temperature as interface temperature of the surfaces (of the sliding ring or mating ring) in contact with the flow medium on the one hand, in particular excluding the surface in the sealing gap, and the other surfaces (of the sliding ring or mating ring) on the other hand. In this case, the evaluation device is configured to estimate, from the heat fluxes, the heat power introduced via the surface in the sealing gap into the one of sliding ring and mating ring on which the ring temperature is determined and to estimate the frictional power on the basis of this introduced heat power. Knowledge of only two temperatures which are known at two known sites or regions in the mechanical seal, specifically at the measurement sites of the ring temperature and medium temperature, allows the heat flux model to be used to ascertain how the heat fluxes behave on account of the temperature gradients in the sliding ring and/or mating ring. The measurement site of the ring temperature should not be in contact with the flow medium, especially in order to enable a temperature gradient (in particular a significant temperature gradient) between the surfaces facing the flow medium and the measurement site. To a good approximation, the temperature at the measurement site corresponds to the medium temperature if the pump has already been at a standstill for a relatively long period of time. As soon as the temperature at the measurement site increases, it is possible to deduce a unquantified heat input in the sealing gap therefrom. Considering the heat fluxes also allows the level of heat input or the heat power into the mating ring and/or sliding ring in the sealing gap to be deduced. This heat power forms a significant component of the entire frictional power.

As an alternative to that or in addition, the heat flux model can be configured to determine heat fluxes (especially internal heat fluxes) between surfaces of the one of sliding ring and mating ring on which the ring temperature is not determined, specifically on the basis of the medium temperature as interface temperature of the surfaces (of the sliding ring or mating ring) in contact with the flow medium on the one hand, in particular excluding the surface in the sealing gap, and the other surfaces (of the sliding ring or mating ring) on the other hand. In this case, the evaluation device is configured to estimate, from the heat fluxes, the heat power introduced via the surface in the sealing gap into the one of sliding ring and mating ring on which the ring temperature is not determined and to estimate the frictional power on the basis of this introduced heat power. Considering the component on which the measurement site has not been placed is naturally less trivial, for which reason this consideration is preferably implemented additionally, i.e. to supplement the observation of the other component of sliding ring and mating ring. Especially if the heat power introduced into the sliding ring and into the mating ring is determined, then the frictional power is the sum of these two heat powers to a good approximation. By contrast, the heat power within the sealing gap directly output to the surrounding flow medium or the pump shaft is neglectable or, for example, easily estimable by factors of proportionality.

Once again, the heat flux model should be configured for the quasi-stationary description of the current heat fluxes in the mechanical seal.

By preference, the evaluation model includes a heat transfer model for describing heat transfer processes away from the mechanical seal, in particular to the flow medium, to adjacent components such as a mating ring seat or a pump shaft and/or to the other surroundings of the mechanical seal. This allows a more precise determination of the heat fluxes because knowledge of the heat transfers allows the establishment of how much energy can be output in which surface region, and ultimately also how much energy is transported to which surface region by the heat fluxes. Provided the flow medium is a liquid, the heat transfer model can to a good approximation be restricted to the heat transfers to the flow medium.

According to a more specific configuration, the data interface is designed to receive a data signal regarding a rotational speed of the sliding ring of the mechanical seal as an input variable of the soft sensor. Knowledge of the rotational speed allows the evaluation to be more precise since for example at very high rotational speeds, and despite the increasing fluid friction, there is an advantageous state with fluid friction that hardly causes wear, whereas the same frictional power may be mixed friction with greater wear at a lower rotational speed. Moreover, the heat transfer model in particular can be improved if the rotational speed is known.

Specifically, provision is made for at least the heat transfer model to be configured to include the data signal regarding the rotational speed of the sliding ring as input variable.

The heat transfer model comprises, in particular, the estimate of the heat transfer coefficient on account of the geometry of the mechanical seal and its rotational speed or the rotational speed of the sliding ring. The heat transfer denotes the transfer of heat between the surface of a solid and a fluid. By preference, a heat transfer between two solids is not described here.

Furthermore, the evaluation model may include a heat conduction model for describing a temperature field in the mechanical seal. In particular, temperatures such as e.g. that on the surface in the gap can be calculated by way of the heat conduction model. To this end, the heat conduction model should include, in particular, the geometry of the mating ring and the thermal conductivity or conductivities of the materials used to form the mating ring; and/or include the geometry of the sliding ring and the thermal conductivity or conductivities of the materials used to form the sliding ring. Specifically, the heat conduction model can be static or quasi-static. The heat conduction model is based (in particular exclusively based) on quasi-stationary states. The measurement values in the model are considered to be stationary at every time step of a measurement value recording cycle. On account of the chosen temperature measurement site, for example on the back of the mating ring of the mechanical seal, dynamic temperature changes on account of a change in frictional power can only be identified with a delay. Thus, dynamic changes in frictional power are reproduced in attenuated fashion. The heat conduction model describes the temperature gradient or the temperature field between the temperature measurement site on the mating ring or sliding ring and the mean gap temperature in the sealing gap. This is advantageous because the ascertained gap temperature can be used to also estimate the heat flux in the other one of mating ring and sliding ring in the mechanical seal without additional measurement values.

According to a very specific configuration of the soft sensor, the heat flux model is configured to include the temperature field according to the heat conduction model and/or the heat transfers according to the heat transfer model as input variables. As a result, it is possible to capture changes in the heat fluxes which in each case given a current temperature field and knowledge of the heat conduction model are present within the mechanical seal and heat transfers between the mechanical seal and its periphery.

Moreover, the temperature field should be configured for the quasi-stationary description of the current local temperatures, i.e. of the temperature field in the mechanical seal.

The invention also relates to a pump (also referred to as a pumping apparatus) having a mechanical seal and a soft sensor as described above and below, the mechanical seal having a sliding ring arranged so as to rotate about a bearing axis and a stationarily arranged mating ring which corresponds via a sealing gap to the sliding ring. The sliding ring is arranged on a pump shaft, in particular with a pump wheel, and the mating ring is arranged in a mating ring seat. Furthermore, the pump has a first temperature sensor designed to measure the ring temperature and communicatively connected to the data interface. Moreover, the pump has a second temperature sensor designed to measure the medium temperature of the flow medium on the side of the mechanical seal facing the sliding ring and outside of the sealing gap and communicatively connected to the data interface.

The pump thus equipped with the soft sensor can now be monitored with regards to the current state of the mechanical seal and also the wear thereof over time, in particular by estimating the frictional power with the aid of the soft sensor models.

By preference, a measurement site of the first temperature sensor is located on a surface of the mating ring not processed for the temperature sensor. In that case, the mating ring requires no surfaces, cutouts, holes or grooves specifically designed for the temperature sensor. As a result, it is also possible to monitor a mechanical seal that has not been specifically prepared for the soft sensor. Furthermore, the measurement site of the temperature sensor is preferably located on a surface which has no contact with the flow medium. As a result, a large temperature gradient is provided as the initial basis for the evaluation model.

According to a more specific configuration of the pump, the sliding ring is axially displaceably mounted along the bearing axis and axially loaded in the direction of the mating ring by a spring force. The sliding ring is pressed against the mating ring in the absence of opposing fluid dynamic forces that arise during rotation in the sealing gap. Depending on the alignment of the bearing axis, weights are also included in the contact pressure. When the sliding ring starts to rotate, flows of the flow medium in the pump interior may exert additional forces on the sliding ring. Only once the fluid dynamic and fluid static forces in the sealing gap exceed the forces acting on the sliding ring does the sliding ring move away from the mating ring and is a sealing gap height that prevents dry friction and mixed friction formed. The frictional power in the sealing gap drops quite significantly as soon as the sealing gap builds up. Subsequently, the frictional power is restricted to fluid friction that emerges from turbulence in the sealing gap within the flow medium and from friction of the flow medium at the sliding ring and mating ring and also from the viscous forces in the sealing gap medium. Wear is at a minimum in the case of fluid friction. This operational state of the mechanical seal should always be sought after.

Moreover, the pump preferably has a rotational speed encoder communicatively connected to the data interface for the purpose of transmitting the data signal regarding the rotational speed of the pump shaft or of the sliding ring. This allows the rotational speed to be considered within the evaluation model.

The fluid friction increases with increasing rotational speed, and so e.g. mixed friction or fluid friction could be deduced not only from knowledge of the frictional power. Therefore, the evaluation device is preferably configured to deduce the frictional state, in particular dry friction, mixed friction and fluid friction, on the basis of knowledge of the rotational speed profile and the current frictional power. On the basis of this, the evaluation apparatus preferably assesses the wear of the mechanical seal.

Furthermore, the sliding ring can be sealed relative to the pump shaft by way of a first secondary seal. This prevents a passage of flow medium between sliding ring and pump shaft, especially past the sealing gap into the surroundings. The secondary seal can be formed by a fit; however, the secondary seal is preferably a separate element, for example an O-ring made of rubber.

Moreover, the mating ring can be sealed relative to the mating ring seat by way of a second secondary seal. The mating ring seat in turn can for example be formed in one piece in a pump housing component, or it can for example be connected to a pump housing component as an installation part.

Furthermore, the invention relates to a computer-implemented method, in particular for determining a frictional power of a mechanical seal by estimation, comprising at least the following steps:
ascertaining a ring temperature of the sliding ring or mating ring, and a medium temperature of the flow medium on a side of the mechanical seal facing the sliding ring and outside of a sealing gap between the sliding ring and the mating ring;
executing an evaluation model comprising a heat flux model, the heat flux model being configured to describe heat fluxes in the mechanical seal on the basis of a temperature difference between the ring temperature and the medium temperature and the evaluation model being configured to deduce the frictional power by way of the heat fluxes,
providing the frictional power.

In principle, the advantages of the method correspond to those of the soft sensor. In this case, the method can in particular also be performed using a soft sensor or a pump as specified above and below.

In particular, the evaluation model may optionally comprise a heat transfer model for describing heat transfer processes away from the mechanical seal, in particular to the flow medium, to adjacent components such as a mating ring seat or a pump shaft and/or to the other surroundings of the mechanical seal.

Finally, the evaluation model can also use a heat conduction model; this especially serves the purpose of a more precise determination of the heat fluxes and/or heat transfers on the basis of the temperature distribution or the temperature field.

Specifically, provision can be made for the execution of the evaluation model to comprise a heat transfer model for describing heat transfer processes between the mechanical seal and at least the surrounding flow medium; and/or a heat conduction model for describing a temperature field in the mechanical seal.

Optionally, the mechanical seal can have a sliding ring arranged so as to rotate about a bearing axis, a stationarily arranged mating ring which corresponds via a sealing gap to the sliding ring and a soft sensor configured to execute the evaluation model, and the method can comprise the following steps:
transmitting the ring temperature and the medium temperature as incoming data signals to the soft sensor;
executing the evaluation model using the soft sensor on the basis of the incoming data signals with the aid of the evaluation model.

In particular, the soft sensor can be designed as described above and below.

Further features, details and advantages of the invention are apparent from the wording of the claims and from the following description of exemplary embodiments on the basis of the drawings, in which:

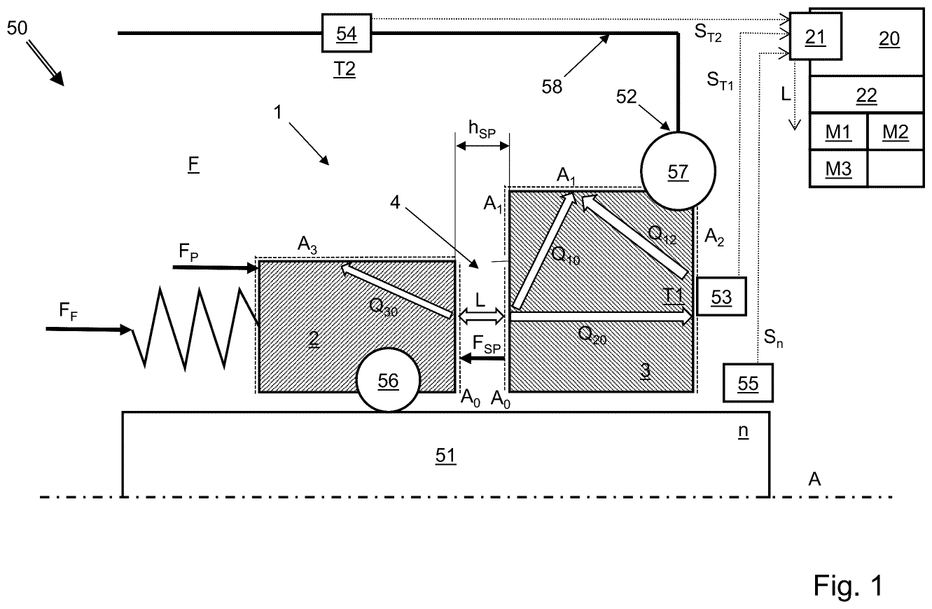

FIG. 1 shows a schematic view of a mechanical seal of a pump with a soft sensor;

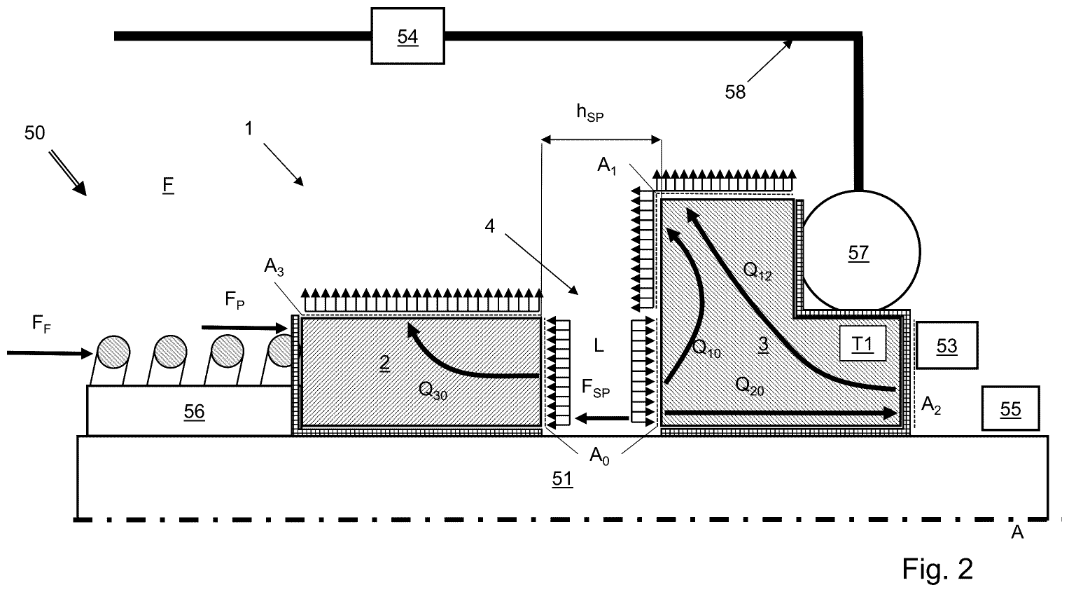

FIG. 2 shows a schematic view of a mechanical seal of a pump;

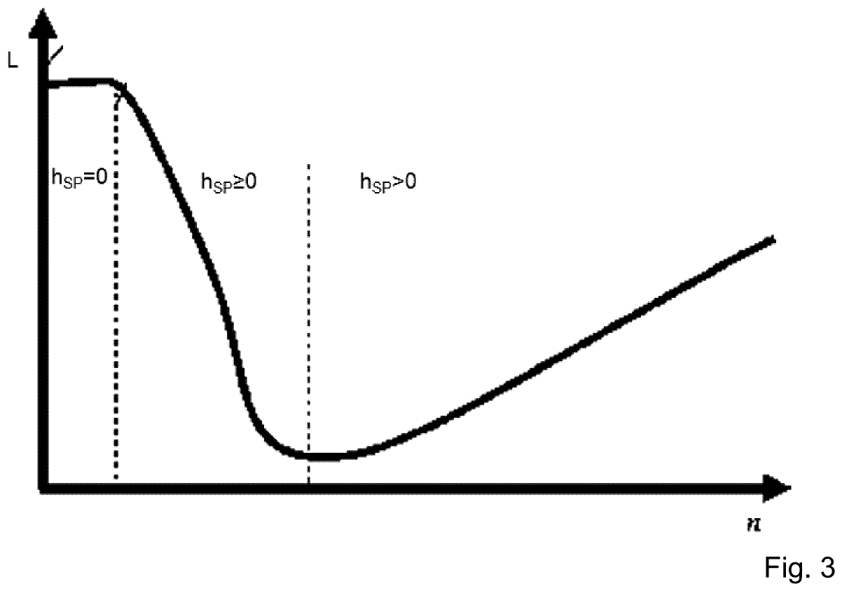

FIG. 3 shows a graph which plots the frictional power of a mechanical seal against rotational speed; and

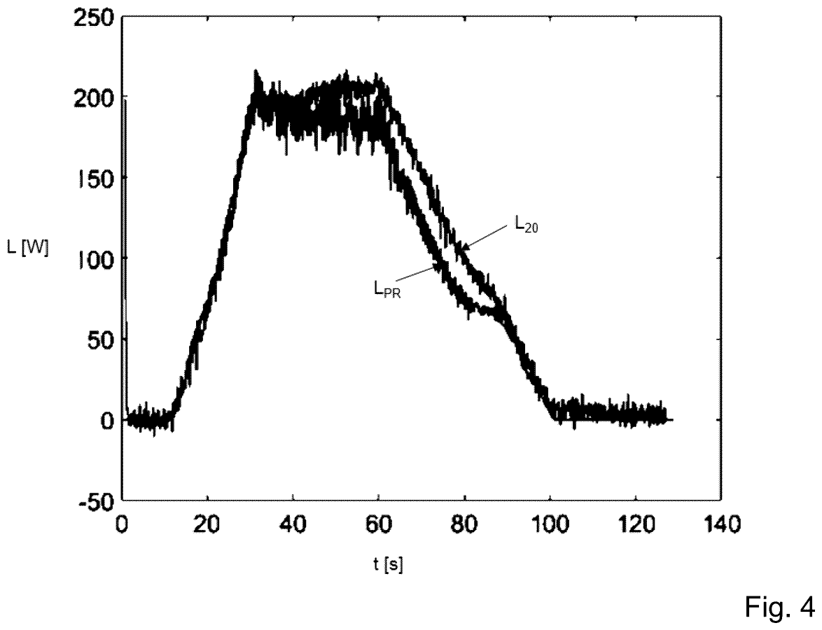

FIG. 4 shows a comparison graph of the frictional power over time, as measured on a test station and estimated by a soft sensor.

FIGS. 1 and 2 each show a schematic detail of a pump 50, in which a mechanical seal 1 is arranged. The mechanical seal 1 has a sliding ring 2 arranged so as to rotate about a bearing axis A and seated on a pump shaft 51. A first secondary seal 56 is seated between the sliding ring 2 and the pump shaft 51. The mechanical seal 1 also comprises a stationarily arranged mating ring 3 which corresponds via a sealing gap 4 to the sliding ring 2. The mating ring 3 is secured in a mating ring seat 52 of a pump housing component 58 and sealed with respect thereto by way of a second secondary seal 57. The sliding ring 2 is mounted on the pump shaft 51 so as to be axially displaceable along the bearing axis A and axially loaded in the direction of the mating ring 3 by a spring force F_{F}. Additionally, further forces F_{P} may act on the sliding ring 2, for example on account of the incoming flow of a flow medium F in the interior of the pump 50. The atmosphere is usually found outside of the pump housing component 58.

In the case of proper operation and proper construction and design of the component parts, a height h_{SP} of the sealing gap increases to greater than 0 during the operation of the mechanical seal 1, whereby the sliding ring 2 and mating ring 3 are separated from one another. Thus, flow medium F can emerge from the pump housing into the atmosphere as a result of the sealing gap >0. Typical heights h_{SP} of the sealing gap 4 during operation are mostly between 100 nm and 10 μm, which is why the leakage of flow medium F through the sealing gap 4 can be considered to be negligibly small. A gap force F_{SP} must act so that the sealing gap 4 between the sliding ring 2 and the mating ring 3 can build up to beyond the height h_{SP}=0. This substantially results from the flow of the flow medium F within the sealing gap 4. The sliding ring 2 separates from the mating ring 3 only once the gap force F_{SP} exceeds the sum of the spring force F_{F} and the other forces F_{P}, optionally plus possible frictional forces of the first secondary seal 56. The gap force F_{SP} also builds up, for example, depending on the structuring of the sliding faces and the dynamics of the sliding ring 2. During the operation of the mechanical seal 1, it is possible to distinguish between three friction states, which are depicted in FIG. 3.

FIG. 3 shows a graph which plots the frictional power L of a mechanical seal 1 against the rotational speed n. In this case, three rotational speed zones are labeled by two vertical, dashed lines. Dry friction is present, and hence also a high frictional power L and significant wear, if the height h_{SP} of the sealing gap 4 is zero. In this case, the frictional power L can be subdivided into a heat input into the sliding ring 2 and a heat input into the mating ring 3. Above a first rotational speed n, the height h_{SP} of the sealing gap 4 is ≥0, and only partial and/or temporary solid contact still is present. This state can be referred to as mixed friction. The component of dry friction becomes ever smaller as the rotational speed n increases, until there is no more solid contact between the sliding ring 2 and the mating ring 3 at a second rotational speed n. This state in which sliding ring 2 and mating ring 3 are completely decoupled is called fluid friction. The frictional power L and the wear reach a minimum here. This operational state of the mechanical seal 1 should be sought after for normal operation. If the rotational speed n is now increased further, there is a further increase in frictional losses L as a result of the fluid dynamics in the sealing gap 4, and this is also reflected in an increasing frictional power L.

The frictional power L in the sealing gap 4 of FIGS. 1 and 2 is derived on account of the resultant temperature delta from the sealing gap 4. In particular, it can be divided into a heat flux Q₃₀ in the sliding ring 2 and heat fluxes Q₁₀, Q₂₀ in the mating ring 3. The heat flux Q₃₀ in the sliding ring 2 occurs between the face A₀ of the sliding ring 2 in the sealing gap 4 and the surface A₃ of the sliding ring 2 in contact with the flow medium F. By contrast, the mating ring 3 is in contact not only with the flow medium F via a surface A₁ but also with the atmosphere via a surface A₂. This then yields essentially two heat fluxes Q₂₀, Q₃₀ to be considered, away from the sealing gap 4 or the surface A₀ in the sealing gap 4 and toward the two faces A₁ and A₂. Since the heat transfer to the flow medium F is substantially more significant than that to the atmosphere (typically air), there is an additional heat flux Q₁₂ between the surfaces A₁ and A₂. To a good approximation, the frictional power L corresponds to the sum of the heat fluxes Q₁₀+Q₂₀+Q₃₀.

The pump 50 according to FIG. 1 additionally comprises a soft sensor 20 with a data interface 21. The pump 50 according to FIG. 2 can also be equipped therewith; however, this is not shown. The soft sensor 20 of FIG. 1 serves to estimate the frictional power L of the mechanical seal 1 with the aid of an evaluation model. The soft sensor 20 receives data signals Sₙ, S_{T1}, S_{T2} via the data interface 21.

One of the data signals Sₙ describes a rotational speed n of the sliding ring 2, by virtue of a rotational speed sensor as rotational speed encoder 55 being used to measure the rotational speed n of the pump shaft 51. Alternatively, the rotational speed n can also be provided directly as a data signal Sₙ from a motor controller as rotational speed encoder 55, for example from a motor controller of a synchronous motor of the pump 50.

A second of the data signals S_{T1} describes a mating ring temperature T1 of the mating ring 3 at a measurement site of a first temperature sensor 53 located in the region of the face A₂ in contact with the atmosphere in particular.

A third of the data signals S_{T2} describes a medium temperature T2 of the flow medium F in the interior of the pump 50, in particular also on the side of the mechanical seal 1 facing the sliding ring 2 and outside of the sealing gap 4. When estimating the frictional power L with the soft sensor 20, this medium temperature T2 serves as an interface temperature of the faces A₁, A₃, i.e. of those faces in particular which are in contact with the flow medium F.

The schematic view of FIG. 1 depicts the gap dimensions of the sealing gap 4 and between the sliding ring 2 and pump shaft 51 and the mating ring 3 and pump shaft 51 in much exaggerated fashion in comparison with reality. Circulation of flow medium F into these gap dimensions and with significant heat transfer out of the sealing gap 4 is typically negligible. Heat fluxes via the gap dimensions to the pump shaft 51 or back into the flow medium F can therefore also be neglected in the estimate. However, these may also be included in the estimate if need be, for example to increase the quality of the estimate; however, this significantly increases the complexity of the estimate or of the evaluation model. A similar statement applies to thermal outflows via the spring or from the mating ring 3 to the mating ring seat 52.

The data signals Sₙ, S_{T1}, S_{T2} each serve as input variables for the soft sensor 20, which has an evaluation device 22 for estimating the frictional power L by evaluating the data signals Sₙ, S_{T1}, S_{T2}. To this end, the evaluation model has a heat flux model M3 which is used to describe the heat fluxes Q₁₀, Q₂₀, Q₃₀, Q₁₂ in the mechanical seal 1 on the basis of a temperature difference between the ring temperature T1 and the medium temperature T2. The evaluation model is configured to deduce the frictional power L by way of these heat fluxes Q₁₀, Q₂₀, Q₃₀, Q₁₂. The heat flux model M3 describes the current (quasi-static) heat fluxes Q₁₀, Q₂₀, Q₁₂ between the surfaces A₀, A₁, A₂ of the mating ring 3 on the basis of the medium temperature T2 as the interface temperature of the surface A₁ of the mating ring 3 in contact with the flow medium F, the ring temperature T1 as interface temperature of the surface A₂ of the mating ring 3 in contact with the surroundings or atmosphere, and the frictional power L to be estimated, which is introduced via the face A₀ located in the sealing gap 4. Moreover, the heat flux model M3 describes the heat flux Q₃₀ between the surface A₃ of the sliding ring 2 in contact with the flow medium F on the one hand and the frictional power L to be estimated, which is introduced via the face A₀ located in the sealing 4. Thus the frictional power L is divided into a heat power component in the direction of the sliding ring 2 and a heat power component in the direction of the mating ring 3. In this case, the level of heat power components depends not only on the size of the face A₀, but especially also on how quickly the heat is emitted again via the faces A₁ and A₃ (optionally also via the face A₂). In this case, influencing variables are the material, material strength, component geometry, flow-around of flow medium F and the type of flow medium F as well.

Described in simplified fashion, it is for example possible to initially determine the heat flux Q₁₂ between the face A₂ and the face A₁ on account of the temperature gradient between ring temperature T1 and fluid temperature T2, wherein the energy of this heat flux Q₁₂ initially reaches the measurement site on face A₂ from the sealing gap 4 with the heat flux Q₂₀. In the case of a liquid flow medium F, the heat flux Q₁₂ can be assumed to be of the same magnitude as the heat flux Q₂₀. Added to this is the direct heat flux Q₁₀ from the sealing gap 4 to the face A₁; it depends on the construction of the mating ring 3. The sum of the heat fluxes Q₁₀ and Q₂₀ corresponds to the component of the frictional power L dissipated from the sealing gap 4 via the mating ring 3. The temperature in the sealing gap 4 is also ascertained within the scope of this heat flux consideration, with the result that the heat flux Q₃₀ flowing from the sealing gap 4 to the flow medium F via the sliding ring 2 is thus ascertainable in turn.

Since the component temperature in this consideration varies over the cross section and exhibits significant local differences, the evaluation model preferably additionally comprises a heat conduction model M1 for describing a temperature field in the mechanical seal 1 and a heat transfer model M2 for describing heat transfer processes away from the mechanical seal 1, in particular to the flow medium F via the faces A₁, A₃ and optionally to the other surroundings, specifically the atmosphere, via the face A₂. The current heat transfers and heat fluxes can be determined precisely with knowledge of the current local temperatures in the mechanical seal 1.

The evaluation model relates the geometry of the mating ring 3 and the thermal conductivity or conductivities of the materials used to form the mating ring 3. Moreover, the geometry of the sliding ring 2 and the thermal conductivity or conductivities of the materials used to form the sliding ring 2 are included. Optionally, geometric changes as a result of wear and tear can be included, for which purpose the estimated frictional power L over the operating time is then preferably used to deduce the wear state and hence the contour of the mechanical seal 1.

The evaluation device 22 is designed to estimate the heat powers introduced into the sliding ring 2 and the mating ring 3 via the interfaces A₀ in the sealing gap 4 with the aid of the evaluation model and the data signals Sₙ, S_{T1}, S_{T2}, and to use this to estimate the frictional power L overall.

To this end, the heat flux model M3 is configured to include the temperature field according to the heat conduction model M1 and the heat transfers according to the heat transfer model M2 as input variables. In this case, the temperature field describes the local temperatures in the mechanical seal 1. The temperature field increases the resolution of the reduced consideration of a few surface regions because it describes the temperature distribution in the sliding ring 2 and mating ring 3 overall. In particular, the quality of the heat transfer model M2 also profits from the more highly resolved temperature distribution within the sliding ring 2 and mating ring 3.

With the exception of the temperature T₀ at the interface A₀ in the sealing gap 4, all surface temperatures important for the estimate are known. One approach for calculating the temperature T₀ of the face A₀ in the sealing gap 4 can lie in the method of form factors. A stationary thermal state is assumed in this case. The form factors a₁₂ and a₂₀ consider variables of the temperature field from the heat conduction model M1 and of the transfer of heat from the heat transfer model M2.

The form factors aⱼᵢ describe the passage of heat from location j to location i, in particular between the faces A₀, A₁, A₂, A₃. They contain information regarding the heat transfer in the form of the heat transfer coefficient a (estimated by the heat transfer model M2), the faces A involved in the passage of heat (contained in the heat conduction model M1) and the passage efficiencies Eⱼᵢ (estimated by the heat conduction model M1).

aⱼᵢ=αAEⱼᵢ

The temperature T₀ in the sealing gap 4 can be calculated as follows:

$$T 0 = \frac{a 12}{a 20} ( T 1 - T 2 ) + T 1$$

The heat flux model M3 is able to calculate the heat fluxes in the direction of the sliding ring 2 and mating ring 3 on the basis of the form factors and the temperature T₀ in the sealing gap 4 determined thus, the calculation being as follows in particular:

$$L = Q 10 + Q 20 + Q 30 = [ \begin{matrix}( a 10 + a 20 + a 30 ) & - ( a 10 + a 30 ) & - a 20\end{matrix} ] [ \begin{matrix}T 0 \\ T 2 \\ T 1\end{matrix} ]$$

Finally, the soft sensor 20 outputs a data signal regarding the estimated frictional power L via the data interface 21.

FIG. 4 shows a diagram with two comparison graphs of the frictional power L (in watts) over the time t (in seconds). On the one hand, the frictional power L_{PR} has been measured by way of a comprehensive test station measurement and, on the other hand, the frictional power L₂₀ has been estimated by way of the soft sensor 20. During the test station measurement, the frictional power L_{PR} of the mechanical seal 1 was determined by way of a measurement using a torque measuring shaft. From the comparison graphs it is evident that the soft sensor 20, by way of the frictional power L₂₀, qualitatively reproduces the frictional power L_{PR} measured by the test station. It transpires that the soft sensor 20 can obtain a good estimate of the frictional power L. Quantitatively, the already configured models M1, M2, M3 and the evaluated form factors aⱼᵢ were able to obtain average estimation qualities of 85%. In this case, the estimated frictional power L₂₀ responded quite sensitively to the variables for describing the heat transfers within the form factors aⱼᵢ. The heat transfer states at the mechanical seal 1 could be measured even more precisely using a greater number of test series and be taken into account in the form factors aⱼᵢ. In this context, it is to be expected that estimation qualities of >90% are obtainable. However, an 85% estimation quality of the frictional power L is already completely sufficient with regards to identifying critical current operating states, e.g. a dry run. The deviation between estimated wear and actual wear should be able to be assumed to be smaller in any case for an ongoing observation of the frictional power L over time because overestimates and underestimates of the frictional power L compensate one another in part. Relatively large deviations of the actual wear from the estimated wear as a result of the estimation of the frictional power L can for example emerge due to contamination of the flow medium F or the like. In view thereof, the estimation quality of the frictional power L of 85% can likewise be dealt with well. A safety cushion in respect of the wear with regards to a seal failure is required in any case.

The invention is not restricted to any of the above-described embodiments but may be modified in a very wide variety of ways.

All of the features and advantages apparent from the claims, the description and the drawing, including structural details, spatial arrangements and process steps, may be essential to the invention both individually and in a very wide variety of combinations.

### LIST OF REFERENCE SIGNS

1 Mechanical seal
2 Sliding ring
3 Mating ring
4 Sealing gap
20 Soft sensor
21 Data interface
22 Evaluation device
50 Pump
51 Pump shaft
52 Mating ring seat
53 First temperature sensor (measures ring temperature)
54 Second temperature sensor (measures medium temperature)
55 Rotational speed encoder
56 First secondary seal
57 Second secondary seal
58 Pump housing component
A Bearing axis
F Flow medium
F_{F} Spring force
F_{P} Other force
F_{SP} Gap force
h_{SP} Gap height
L Frictional power
L₂₀ Estimated frictional power according to the soft sensor
L_{Pr} Comparison frictional power according to the test station
M1 Heat conduction model
M2 Heat transfer model
M3 Heat flux model
n Rotational speed of the sliding ring
Sₙ Data signal regarding the rotational speed n
S_{T1} Data signal regarding the ring temperature T1
S_{T2} Data signal regarding the medium temperature T2
t Time
T1 Ring temperature
T2 Medium temperature

1. A soft sensor (20), in particular for determining a frictional power (L) of a mechanical seal (1) by estimation,
having a data interface (21) designed to receive data signals (Sₙ, S_{T1}, S_{T2}) regarding
a) a ring temperature (T1) of a sliding ring (2) or mating ring (3) of the mechanical seal (1) and
b) a medium temperature (T2) of the flow medium (F) on the side of the mechanical seal (1) facing the sliding ring (2) and outside of a sealing gap (4) between the sliding ring (2) and the mating ring (3),
in each case as an input variable of the soft sensor (20), and
having an evaluation device (22) designed to estimate the frictional power (L) by evaluating the data signals (Sₙ, S_{T1}, S_{T2}), for which purpose the evaluation device (22) has an evaluation model comprising a heat flux model (M3), the heat flux model (M3) being configured to describe heat fluxes in the mechanical seal (1) on the basis of a temperature difference between the ring temperature (T1) and the medium temperature (T2) and the evaluation model being configured to deduce the frictional power (L) by way of the heat fluxes.

2. The soft sensor (20) as claimed in claim 1, wherein the evaluation device (22) is configured to estimate the frictional power (L) in accordance with the heat flux model (M3) by way of an estimated heat power introduced into the mechanical seal (1) in the sealing gap (4).

3. The soft sensor (20) as claimed in claim 1, wherein the evaluation model includes the geometry of the mating ring (3) and the thermal conductivity or conductivities of the materials used to form the mating ring (3).

4. The soft sensor (20) as claimed in claim 1, wherein the evaluation model includes the geometry of the sliding ring (2) and the thermal conductivity or conductivities of the materials used to form the sliding ring (2).

5. The soft sensor (20) as claimed in claim 1, wherein the heat flux model (M3) is configured to determine heat fluxes between surfaces of the one of sliding ring (2) and mating ring (3) on which the ring temperature (T1) is determined, specifically on the basis of the medium temperature (T2) as interface temperature of the surfaces in contact with the flow medium (F) on the one hand, in particular excluding the surface in the sealing gap (4), and the other surfaces on the other hand,
with the evaluation device (22) being configured to estimate, from the heat fluxes, the heat power introduced via the surface in the sealing gap (4) into the one of sliding ring (2) and mating ring (3) on which the ring temperature (T1) is determined and to estimate the frictional power on the basis of this introduced heat power.

6. The soft sensor (20) as claimed in claim 1, wherein the heat flux model (M3) is configured to determine heat fluxes between surfaces of the one of sliding ring (2) and mating ring (3) on which the ring temperature (T1) is not determined, specifically on the basis of the medium temperature (T2) as interface temperature of the surfaces in contact with the flow medium (F) on the one hand, in particular excluding the surface in the sealing gap (4), and the other surfaces on the other hand,
with the evaluation device (22) being configured to estimate, from the heat fluxes, the heat power introduced via the surface in the sealing gap (4) into the one of sliding ring (2) and mating ring (3) on which the ring temperature (T1) is not determined and to estimate the frictional power on the basis of this introduced heat power.

7. The soft sensor (20) as claimed in claim 1, wherein the evaluation model includes a heat transfer model (M2) for describing heat transfer processes away from the mechanical seal (1), in particular to the flow medium (F), to adjacent components such as a mating ring seat (52) and/or to the other surroundings of the mechanical seal (1).

8. The soft sensor (20) as claimed in claim 1, wherein the data interface (21) is designed to receive a data signal (Sₙ) regarding a rotational speed (n) of the sliding ring (2) of the mechanical seal (1) as an input variable of the soft sensor (20).

9. The soft sensor (20) as claimed in claim 1, wherein the evaluation model includes a heat transfer model (M2) for describing heat transfer processes away from the mechanical seal (1), in particular to the flow medium (F), to adjacent components such as a mating ring seat (52) and/or to the other surroundings of the mechanical seal (1), the data interface (21) is designed to receive a data signal (Sₙ), regarding a rotational speed (n) of the sliding ring (2) of the mechanical seal (1) as an input variable of the soft sensor (20), and at least the heat transfer model (M2) is configured to include the data signal (Sₙ) regarding the rotational speed (n) of the sliding ring (2) as input variable.

10. The soft sensor (20) as claimed claim 1, wherein the evaluation model includes a heat conduction model (M1) for describing a temperature field in the mechanical seal (1).

11. A pump (50) having a mechanical seal (1) and a soft sensor (20) as claimed in claim 1,
the mechanical seal (1) having a sliding ring (2) arranged so as to rotate about a bearing axis (A) and a stationarily arranged mating ring (3) which corresponds via a sealing gap (4) to the sliding ring (2),
the sliding ring (2) being arranged on a pump shaft (51) and the mating ring (3) being arranged in a mating ring seat (52),
having a first temperature sensor (53) designed to measure the ring temperature (T1) and communicatively connected to the data interface (21), and
having a second temperature sensor (54) designed to measure the medium temperature (T2) of the flow medium (F) on the side of the mechanical seal (1) facing the sliding ring (2) and outside of the sealing gap (4) and communicatively connected to the data interface (21).

12. The pump (50) as claimed in claim 11, wherein the sliding ring (2) is axially displaceably mounted along the bearing axis (A) and axially loaded in the direction of the mating ring (3) by a spring force.

13. The pump (50) as claimed in claim 11, wherein said pump has a rotational speed encoder (55) communicatively connected to the data interface (21) for the purpose of transmitting the data signal (Sₙ) regarding the rotational speed (n) of the pump shaft (51) or of the sliding ring (2).

14. A computer-implemented method, in particular for determining a frictional power (L) of a mechanical seal (1) by estimation, comprising at least the following steps:
ascertaining the following:
a) a ring temperature (T1) of a sliding ring (2) or mating ring (3) of the mechanical seal (1); and
b) a medium temperature (T2) of the flow medium (F) on a side of the mechanical seal (1) facing the sliding ring (2) and outside of a sealing gap (4) between the sliding ring (2) and the mating ring (3);
executing an evaluation model comprising a heat flux model (M3), the heat flux model (M3) being configured to describe heat fluxes in the mechanical seal (1) on the basis of a temperature difference between the ring temperature (T1) and the medium temperature (T2) and the evaluation model being configured to deduce the frictional power (L) by way of the heat fluxes,
providing the frictional power (L).

15. The computer-implemented method as claimed in claim 14, wherein
a heat transfer model (M2) for describing heat transfer processes between the mechanical seal (1) and at least the surrounding flow medium (F); and/or
a heat conduction model (M1) for describing a temperature field in the mechanical seal (1);
are comprised in the execution of the evaluation model.

16. The computer-implemented method as claimed in claim 14, the mechanical seal (1) having a sliding ring (2) arranged so as to rotate about a bearing axis (A) and a stationarily arranged mating ring (3) which corresponds via a sealing gap (4) to the sliding ring (2), and having a soft sensor (20) configured to execute the evaluation model, and comprising the following steps:
transmitting the ring temperature (T1) and the medium temperature (T2) as incoming data signals (Sₙ, S_{T1}, S_{T2}) to the soft sensor (20);
executing the evaluation model using the soft sensor (20) on the basis of the incoming data signals (Sₙ, S_{T1}, S_{T2}) with the aid of the evaluation model.
